(19) United States
(12) Patent Application Publication
(10) Pub. No.: US 2021/0234228 A1
(43) Pub. Date: Jul. 29, 2021

(54) DISCOVERING THE METHOD OF EXTRACTING HYDROGEN GAS FROM WATER AND SAVING HYDROGEN GAS WITH HIGH ENERGY EFFICIENCY

(71) Applicants: Majid ASGARI, Isfahan (IR); Farshid PAZROFTEH, Hafshejan (IR)

(72) Inventors: Majid ASGARI, Isfahan (IR); Farshid PAZROFTEH, Hafshejan (IR)

(21) Appl. No.: 17/275,189

(22) PCT Filed: May 25, 2019
(86) PCT No.: PCT/IR2019/050017

§ 371 Date: Mar. 10, 2021

(30) Foreign Application Priority Data
Sep. 10, 2018 (IR) 13975014000300506

(51) Int. Cl. H01M 50/392; H01M 10/08; H01M 10/42; H01M 10/44; H01M 50/383; C25B 15/08; C25B 1/04; F24H 9/20

(52) U.S. Cl. CPC H01M 50/392; H01M 10/08; H01M 10/425; H01M 10/441; H01M 2300/0014; C25B 15/08; C25B 1/04; F24H 9/2035; H01M 2300/0005; H01M 50/383

(57) ABSTRACT

The discovery of the method of extracting hydrogen gas from water and saving the high-energy hydrogen gas is a system used by acid-lead batteries and their electrolyte replacement, which removes hydrogen from the water during charging, and then the electricity consumed for this purpose. The battery float charge mode is stored in the battery by chemical reactions. Also, by reversible reactions, a little more than the hydrogen gas is released into the normal amount of gas from the battery houses. By this method, the practical steps are to finalize the sample during the Gaseous hydrogen is recommended for industry and industry.

### TECHNICAL FIELD

Chemistry-Electronics-Energy

### BACKGROUND ART

During the time when the inventors of the project on the invention of steam, the need for fossil fuels and electricity in Iran under patent number 97879 and the application number 13975014003005069, were seeking a method for separating hydrogen gas from water with the least power consumption. They produced samples of cells and were able to get through the experiments and investigations and to make the prototype of the system to the final stages.

### TECHNICAL PROBLEM

The method of using hydrogen gas in systems that consume from production and consumes electrolysis of water, as well as electrolysis of water in some areas for the industrial use of hydrogen with high energy consumption to break the water atoms. In general, the electron The cleanliness of the system can be achieved less than the amount of electrons used to react. This makes hydrogen expensive in terms of energy and cost.

### THE EXISTING PROBLEM SOLUTION

As the technical problem is mentioned, hydrogen is a gas that needs high levels of electricity to isolate water, and in the process of methane gas reformation this gas is also high-cost. Hydrogen is a very valuable gas because it has a very high energy content and a high Electron and, on the other hand, it does not have any kind of arousal for the environment after burning. It also has special uses in the industry and the chemical. The other part of this plan, in order to solve this problem, was thought to be that an electric that was used to separate hydrogen from Save water. Consequently, they were thinking of designing cells to store electricity and to separate the hydrogen gas from the water in order to receive very little electrons. They came to the conclusion by designing and operating on a few piles. The acid-lead batteries are ready-made powders with lead and lead oxide electrodes. In the final stages of charging acid-lead batteries, the charge water phase of the water-electrolysis reaction is charged. In this reaction, due to the fact that the charger It has an open circuit. The charging voltage is higher than the rated voltage of the battery, which causes electrolysis. The charge is also charged.

Then the inventors thought of electrolyte that, in addition to electrolysis of water, in the secondary reaction, hydrogen gas was separated by reversible reactions from the water. By testing on different salts as electrolytes, also the acids and bases found the available method and electrolyte Potassium hydroxide was used to do this. Hydroxide potassium or potash is an alkaline electrolyte whose electron ions are as high as the amount of ions in the acid. By pouring this electrolyte into lead-acid batteries in the process of charging hydrogen gas, a reversible reaction occurs in a water-floating state in addition to water electrolysis, ie, potassium reaction with water, which results in the production of hydrogen gas, and the electrical current in the battery Charging and discharging reactions are:

In Discharging:
In anode: 2pbo₂+2k⁺=pbo+k₂o+e⁺Pbo+koh=k2pbo2+h2o
In the cathode: pb+oh−−=pboh2+2e−

### On Charge:

In the cathode: pboh2+2k+=2koh+pb+e+
In anode: oh+2k*+k2pbo2=pbo₂+2k++2koh+2e−−2k++2h₂o=2koh+

[symbol]

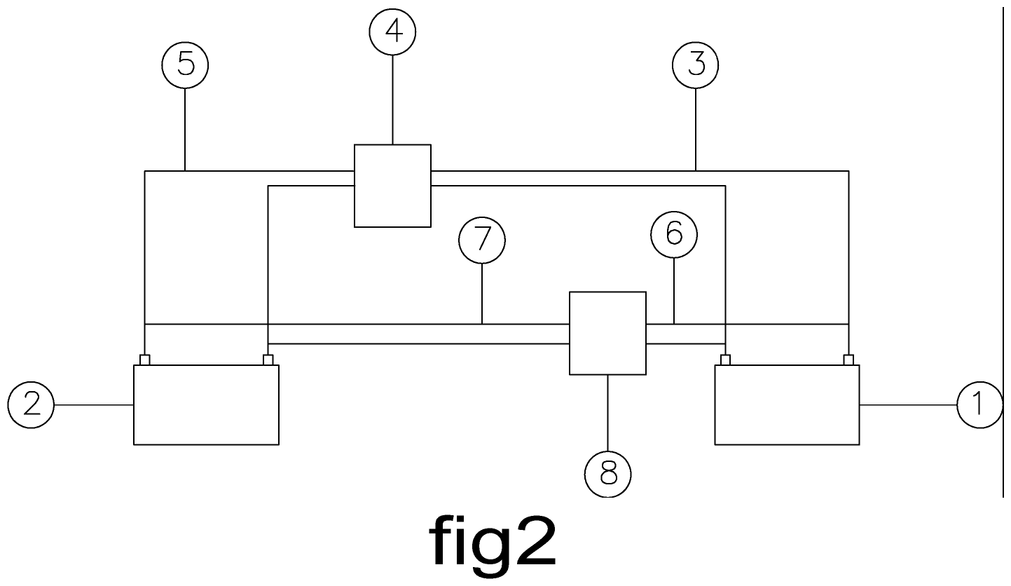

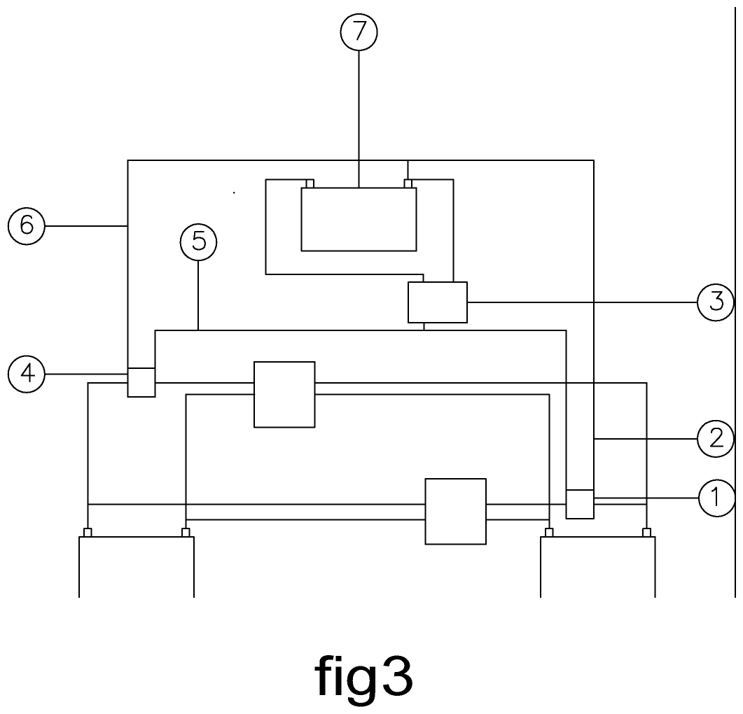

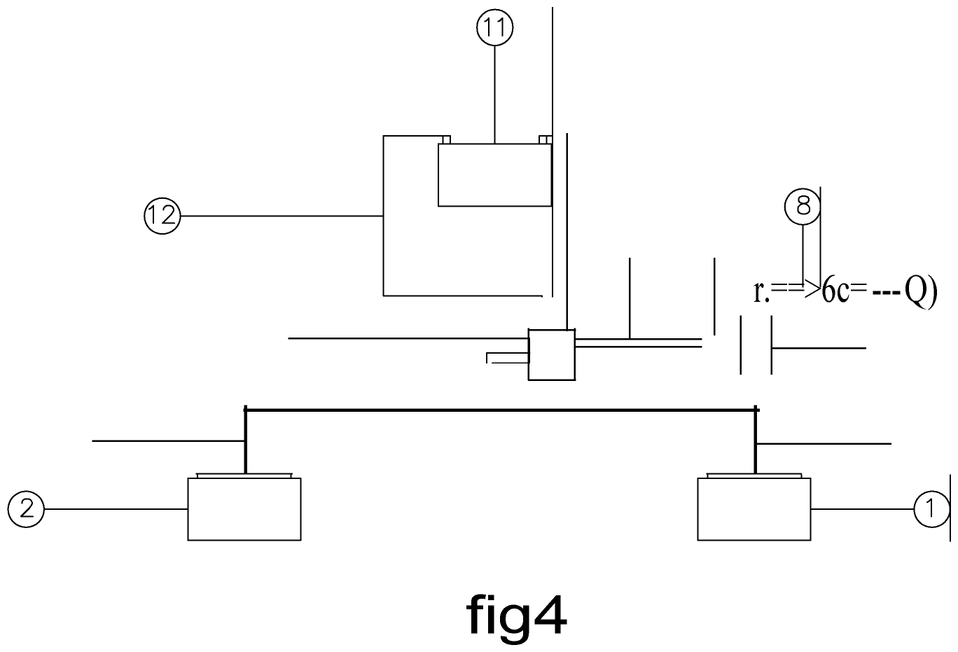

As we see in the reactions, the reaction of potassium with water a potassium hydroxide molecule and a hydrogen atom of hydrogen gas is actually charged. We know that the ions themselves have electrons and are separated by the exchange of electrons between hydrogen ions from molecules of water. To carry out the battery charging process, two or more of the batteries required are needed for the gas. The prototype uses two batteries. In order to make the current or charging, we need to have an orbital circuit like the charging circuit, so we can Use voltage-increasing circuits between batteries. Each battery is connected to a voltage augmentation circuit and its output is connected to another battery (FIG. 2) . . . Now if we make the same flow, we will use a battery as a source and a battery as a consumer of current, and the battery will be completely discharged. Therefore, we need to use the relay to recharge a battery for a while, and a photo of this The action is at another time by the second relay. The battery that is first charged in the discharge mode to the other battery after charging is recharged and the second battery is charged to discharge mode(FIG. 3). It needs to be explained that the relays and amplifiers must be high-impeded that there is no problem with the system and there is less heat loss. To disconnect and relay the relays, each of which are disconnected at a fixed time, from one A timer is used. This timer attaches to the relay and disconnects and relays at a specific time that it is applied. It needs to be explained that the best voltage available for the 18V power supply circuitry is in the form of a charger Open circuit. For timer flow and relay switching from a battery to compensate for this system as well as the pumping system Ga We will also compensate for the loss-making and low-voltage multiplier circuits and high amperage battery may not need to replace electrolytes (FIG. 3 number 7), (FIG. 4 number 11}. Therefore, the consumption of the electrical current required to extract hydrogen gas from the water by this gas-flow pump system is a negligible increase in timing circuits. Thus, taking into account the current flow between the batteries continuously, by calculating at least 7 amps and 16 The volt equal to 102 watts, which is electrolyzed with this volume, and the stoichiometric calculation of the same amount of 102 watts is carried out according to the reversible reaction, which is equal to 200 watts of electricity in the electrolysis. Now, to calculate the input energy of the system, which is the same The current used by the battery to compensate for the drop is equal to a maximum of 12 volts And 1 ampere for pumping, 12 volts and 2 amps for the timer system and relays, as well as 12 volts and 0.5 amps for the loss of circuits equal to 12 and a bit and 3.5 amperes in total, which is considered at a maximum of 42 watts We can extract hydrogen gas by consuming 42 watts from a 200 watt-dropped battery. It needs to be explained. To increase the amount of gas, as well as increasing the number of batteries, the gas can be increased to the desired level. For charging The battery can be compensated for by using a solar panel or thermoelectric from where the hydrogen is used at the place of consumption, which is the total loss offset Energy does not cost you.

Considering the need for 4000 watts of electricity to extract one cubic meter of hydrogen per hour, the system extracts one cubic meter of hydrogen gas in 20 hours and its energy consumption is in the 24 hours, which is the same electrical drops. For economic reasons, the cost of electrical loss in 24 The clock is up to 1000 watts, and the return energy is 4000 watts. In terms of efficiency, the energy efficiency is 4 times in 24 hours. That is, even if a battery is compensated for by the city's electric power or a meter instead of the battery, its cost is 1 unit and the cost The information we receive is 4 units. In terms of financial cost, 1 kilowatt is equal to 1,000 tomans of Iran, and in terms of returns of thirty Subject 1 to 2 million cubic meters of hydrogen gas economical USD. Once this system is great for the consumer. In the other part of the system, gas collection equipment includes a pump, a collecting chamber that is closed on battery houses, as well as a collection tank and flashbacks. The battery is pumped through the battery compartments and into the tank. The inlet and outlet of the flashback tank are located between the hose. The main use of this hydrogen fueling system is at the place of use and use in place and to save its separation from water.

### Benefits of Invention

This invention is economically and energy efficient in comparison with all hydrogen extraction projects from the point of view of the economy and energy, so that in general the inlet and outlet energy has a high profitability ratio. Even if hydrogen is used to separate hydrogen from renewable energy sources You can compare the input and output energy with this system, and economically and electronly recover from hydrogen or electron recycling. This system is usable in all locations and works at very low or very high temperatures.

### DESCRIPTION OF DRAWINGS

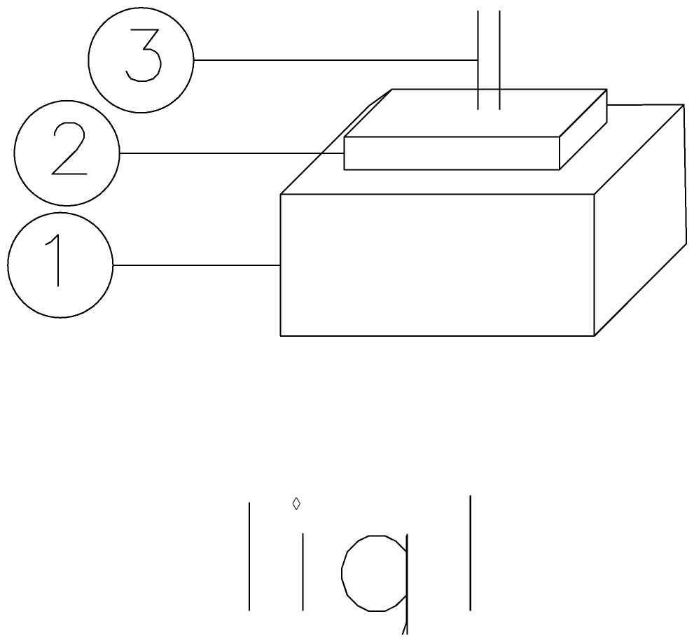

FIG. 1 shows the battery and gas collection point and shows three parts that contain
No. 1: Acidic Lead Battery with Potassium Hydroxide Electrolyte
No. 2: Closed enclosure on battery houses
No. 3: Outlet hose from the chamber to transport hydrogen gas

FIG. 2—Map 2 illustrates the performance of the voltage-increasing voltage circuits between the batteries, which includes:
No. 1: The first battery
No. 2: The second battery
No. 3: Input wires of the first voltage augmentation circuit
No. 4: The first voltage augmentation circuit
No. 5: Output wires of the first voltage augmentation circuit
No. 6: Output wires of the second voltage augmentation circuit
No. 7: Input wires of the second voltage augmentation circuit
No. 8: Secondary voltage augmentation circuit

FIG. 3—In Map 3, the relay placement and timer are displayed in the system, which includes:
No. 1: Second voltage voltage augmentation relay
No. 2: Connect the relay to the battery
No. 3: Timer
No. 4: First voltage boosting relay
No. 5: Output Timer Timer to disconnect relays
No. 6: Connect the relay to the battery
No. 7: Battery Drop Down

FIG. 4 shows the gas extraction system on the map 4 of the batteries. In this map, the electrical system is not shown for better understanding of this system.
No. 1: The first battery
No. 2: The second battery
No. 3: The hose of the first battery outlet
No. 4: Secondary Battery Outlet Hose
No. 5: suction and blow pump
No. 6: Expansion tank or gas collection
No. 7: Gas Outlet
No. 8: Flashback after the tank
No. 9: Flashback before the tank
No. 10: Hose for transferring hydrogen gas from pump to reservoir
No. 11: Drop Down Battery
No. 12: Battery connector for charging the pump to the battery

### EXECUTION METHODS

The invention is based on the method used to extract hydrogen from water, and can sell hydrogen at lower prices, use hydrogen from production in the place of consumption, as well as in other energy-consuming systems such as urban gas in homes, automobiles Generators. It should be explained how the circuits between the batteries can be changed, or other electrical methods for charging electricity can be used that increase gas production. The best part is the use of this system in cars, the dynamo is fully responsible for the circuits and is extracted continuously from the battery of hydrogen gas and the fuel is supplied to the car. If there is a problem in any part of the design, the same part can be repaired or replaced.

1. System for extracting hydrogen gas from water and saving high-energy hydrogen gas, has two or more lead acid batteries, the required electrolyte, ie, concentrated potassium hydroxide, an electrical system for the flow of acid batteries, a drop-down battery, and an extraction system Gas.

2. As claimed in clause 1, this system requires at least two lead acid batteries, which should be at least 45 amps in order for the charge current to exceed 5 amperes to enter the required gas. Hydrogen gas is collected from the houses of these batteries. The electrolyte is brought to the tank and the gas is transferred to the reservoir. The electrolyte of these batteries is exchanged and produced by chemical reactions simultaneously with the supply of hydrogen gas.

3. According to claim 1, this system requires potassium hydroxide instead of sulfuric acid to react with the desired chemical reactions. The concentration of electrolyte can be exactly as acid concentration and add to h2o and the overall reaction to The charge and discharge face is as follows:
Discharge:pbo2+2koh+2k++pb+oh−−k2o+k2pbo2+h2o+pb(oh)+e−
Charge:pb(ohh+k2pbo2+2k+k20+h20+0h 2koh+pbo2+Pb+4koh+o2+h2+2e

4. As stated in clause 1 of the electric system, charging the battery between the batteries has the function of charging the batteries in order to extract the hydrogen gas charge in practice. This system is placed between the batteries and each battery adds a voltage augmentation circuit which is tasked This operation circuit is similar to the charger of a battery that is the source of this other battery. At the output of the circuits, the applied voltage and maximum flow through the potentiometers can be adjusted. (FIG. 2)

5. As claimed in clause 4, the relay is used in the output of the amplifier circuits, which are connected to the timer by the timer. The timer are used to activate the relay for a few minutes and the electric current from the battery to the battery The second is established and at another time, the current of this relay is interrupted and another relay is connected and the current from the second battery is connected to the first battery.

6. As claimed in clause 5, a timer connected to the charge-compensated battery has the function of disconnecting the relays. This time can be set by the timer to get the most gas from the batteries (FIG. 3-number 3).

7. According to claim 1, this system has a drop-down battery, which uses the battery to disconnect and connect circuits, help other batteries to reduce electrical current in augmentation circuits, establish electrical current for the pump to pump the gas in the reservoir (FIG. 4-number 11} (FIG. 3-number 7)

8. According to claim 1, this system has a gas extraction unit that is closed on a container battery house that has the ability to open and close it for the purpose of controlling the houses of the battery and closes on this hollow box until the gas Put the pump into the reservoir (FIG. 1-number 2).

9. According to claim 8, the gas extraction system must be flash-driven before and after the tank to prevent gas or spark leaking into the reservoir and pump.

10. According to claim 8, the gas extraction system should have strong, principled and durable connections to prevent leakage and explosion of hydrogen gas.
